(19) United States
(12) Patent Application Publication
(10) Pub. No.: US 2020/0196005 A1
(43) Pub. Date: Jun. 18, 2020

(54) METHOD AND APPARATUS FOR DATA PROCESSING

(71) Applicant: LONTIUM SEMICONDUCTOR CORPORATION, Hefei (CN)

(72) Inventors: Shenghui BAO, Hefei (CN); Jin SU, Hefei (CN); Guo WEI, Hefei (CN); Shengquan HU, Hefei (CN)

(21) Appl. No.: 16/704,279

(22) Filed: Dec. 5, 2019

(30) Foreign Application Priority Data
Dec. 17, 2018 (CN) 201811542978.5

(51) Int. Cl. H04N 21/433; G06F 16/23; G06F 12/0875; H04N 21/44; H04N 21/443

(52) U.S. Cl. CPC H04N 21/4331; G06F 16/2365; G06F 12/0875; G06F 2212/455; H04N 21/4435; G06F 2212/1024; H04N 21/44004

(57) ABSTRACT

A method and an apparatus for data processing are provided. In the method and apparatus, compressed image data including N pieces of compressed image slice data each composed of invalid and valid data is received; when storing the N pieces of compressed image slice data into a memory, writing of a piece of compressed image slice data corresponding to the invalid data is stopped on detecting that a preset amount of invalid data has been continuously stored in the memory; and the piece of compressed image slice data in the memory is read, and an image slice is obtained by decoding valid data in the piece of compressed image slice data.

### CROSS-REFERENCE TO RELATED APPLICATIONS

The present invention claims priority under 35 U.S.C. § 119 to Chinese Application No. 201811542978.5, filed Dec. 17, 2018, the disclosure of which is incorporated herein by reference in its entirety.

### FIELD

The present application relates to the technical field of high-speed interface and image processing, and in particular to a method and an apparatus for data processing to realize ultra-high-bandwidth video transmission.

### BACKGROUND

The technology of real-time video transmission is widely used in our life with the development of the society. For example, monitoring equipment is installed on the road and in each residential community. The monitoring equipment is applied to transmit a video image currently collected to a monitoring room by means of video transmission technology, to achieve the purpose of monitoring. The technology of real-time video transmission is also applied to exciting live sports events, to realize a live broadcast of the sports events.

In the conventional technology of real-time video transmission, an original image in a video is compressed. Firstly, the original image is divided into multiple slices by a compression module Encoder, where a height and a width of each slice may be configured freely within a certain range. Then the Encoder compresses each slice according to a preset compression ratio. A width of each slice in a horizontal direction becomes 1/N of an original width of each slice, and a width of each slice in a vertical direction is unchanged. A total data size of the image is hereby smaller than 1/N of a total data size of the original image. Finally, invalid data is filled at the end of each slice, and compressed data is obtained. The compressed data is sent to a receiving terminal through the standard DP1.4, MIPI DSI 1.3.1 or HDMI2.1 protocol. After receiving compressed data, a receiver at the receiving terminal stores the compressed data into a memory. When all the data of a frame is stored in the memory, a decoder begins to read the compressed data and restore the compressed data back to the original image, thus the process of real-time video transmission is realized.

However, when the receiver at the receiving terminal receives the compressed data and stores it into the memory, only after a full frame of data has been stored in the memory does the decoder begin to read the compressed data and restore the compressed data back to the original image, only after which does the receiver store compressed data of a next frame into the memory. In order to read the data only after all the data of a frame has been stored in the memory, and further to prevent overflow of the compressed data in the memory, a large storage capacity is required by the memory.

### SUMMARY

In view of the above, a method and an apparatus for data processing are provided according to embodiments of the present disclosure, to store and read compressed image data by slices, and thereby to solve the problem that a memory with a large capability is required to store all the data of a frame.

To resolve the above object, the following technical solutions are provided according to embodiments of the present disclosure.

In one aspect, a method for data processing is provided according to the present disclosure.

The method for data processing includes:

receiving compressed image data, where the compressed image data includes N pieces of compressed image slice data and each piece of compressed image slice data includes invalid data and valid data;

stopping writing, on detecting that a preset amount of invalid data has been continuously written in a memory during the process of sequentially storing the N pieces of compressed image slice data into the memory, a piece of compressed image slice data corresponding to the invalid data; and

reading the piece of compressed image slice data written in the memory, and decoding valid data in the piece of compressed image slice data to obtain an image slice corresponding to the piece of compressed image slice data.

Preferably, after stopping writing the piece of compressed image slice data corresponding to the invalid data, the method further includes:

storing, on detecting valid data of a next piece of compressed image slice data in the compressed image data, the next piece of compressed image slice data into the memory.

Preferably, before receiving the compressed image data, the method further includes:

determining whether data to be transmitted is a kind of data in an image set, where the data in the image set includes compressed image data and original image data;

transmitting the compressed image data through a video transmission interface in a case that the data to be transmitted is the compressed image data in the image set, where the compressed image data includes N pieces of compressed image slice data; and

dividing the original image data into N image slices, compressing each of the N image slices, and transmitting obtained compressed image data through the video transmission interface, in a case that the data to be transmitted is the original image data in the image set.

Preferably, compressing each of the N image slices includes:

compressing a width of each of the N image slices, to obtain compressed data of each image slice; and

adding invalid data at the end of the compressed data of each image slice to conform the compressed data of each image slice to a preset compression ratio, to obtain the compressed image data corresponding to the N image slices.

Preferably, before reading the piece of compressed image slice data written in the memory, the method further includes:

determining whether the amount of data in the memory reaches a preset threshold; and

storing the next piece of compressed image slice data into the memory until the amount of data in the memory reaches the present threshold, if it is determined that the amount of data in the memory does not reach the preset threshold.

Preferably, reading the piece of compressed image slice data written in the memory, and decoding the valid data in the piece of compressed image slice data to obtain the image slice corresponding to the piece of compressed image slice data include:

reading the piece of compressed image slice data stored in the memory;

storing the piece of compressed image slice data into a cache;

reading the valid data in the piece of compressed image slice data stored in the cache; and

decoding the valid data, to obtain the image slice corresponding to the piece of compressed image slice data.

Preferably, after obtaining the image slice corresponding to the piece of compressed image slice data, the method further includes:

deleting invalid data in the piece of compressed image slice data in the cache.

In another aspect, an apparatus for data processing is provided according to the present disclosure.

The apparatus for data processing includes: a receiving module, a writing module and a processing module,

where the receiving module is configured to receive compressed image data, where the compressed image data includes N pieces of compressed image slice data and each piece of compressed image slice data includes invalid data and valid data;

the writing module is configured to stop writing, on detecting that a preset amount of invalid data has been continuously written in a memory during the process of sequentially storing the N pieces of compressed image slice data into the memory, a piece of compressed image slice data corresponding to the invalid data; and

the processing module is configured to read the piece of compressed image slice data written in the memory, and decode valid data in the piece of compressed image slice data to obtain an image slice corresponding to the piece of compressed image slice data.

Preferably, the apparatus further includes a determination module and an image compression module,

where the determination module is configured to:

determine whether data to be transmitted is a kind of data in an image set, where the data in the image set includes compressed image data and original image data; and

transmit the compressed image data through a video transmission interface in a case that the data to be transmitted is the compressed image data in the image set, where the compressed image data includes N pieces of compressed image slice data, and execute the image compression module in a case that the data to be transmitted is the original image data in the image set; and

the image compression module is configured to divide the original image data into N image slices, compress each of the N image slices and transmit obtained compressed image data through the video transmission interface.

Preferably, the processing module includes:

a first reading unit, configured to read the piece of compressed image slice data stored in the memory;

a storage unit, configured to store the piece of compressed image slice data into a cache;

a second reading unit, configured to read the valid data in the piece of compressed image slice data stored in the cache; and

a processing unit, configured to decode the valid data, to obtain the image slice corresponding to the piece of compressed image slice data.

According to the method and apparatus for data processing according to the present disclosure, compressed image data is received, the compressed image data includes N pieces of compressed image slice data, and each piece of compressed image slice data includes invalid data and valid data; during the process of sequentially storing the N pieces of compressed image slice data into a memory, on detecting that a preset amount of invalid data has been continuously stored in the memory, writing of a piece of compressed image slice data corresponding to the invalid data into the memory is stopped; and the piece of compressed image slice data stored in the memory is read, and valid data in the piece of compressed image slice data is decoded to obtain an image slice corresponding to the piece of compressed image slice data. By the above method for data processing, the large amount of invalid data in the compressed image data is not stored in the memory, and it is not required that only after compressed image data of a frame is completed stored in the memory can the data in the memory be read and decoded. In this way, compressed image slice data in the memory can be read when compressed image slice data is being written, thereby greatly reducing capacity requirement on the memory.

### BRIEF DESCRIPTION OF THE DRAWINGS

In order to illustrate technical solutions in the embodiments of the present application or in the conventional technology clearly, drawings to be used in the description of the embodiments or the conventional technology are briefly described below. It is apparent that the drawings in the following description only show some embodiments of the present application, and other drawings may be obtained by those skilled in the art according to these drawings without any creative work.

FIG. 1 is a flow chart of a method for data processing according to an embodiment of the present disclosure;

FIG. 2 is a flow chart of a method for data processing according to an embodiment of the present disclosure;

FIG. 3 is a flow chart of a method for data processing according to an embodiment of the present disclosure;

FIG. 4 is a flow chart of a method for data processing according to an embodiment of the present disclosure;

FIG. 5 is a flow chart of a method for data processing according to an embodiment of the present disclosure;

FIG. 6 is a flow chart of a method for data processing according to an embodiment of the present disclosure;

FIG. 7 is a structural schematic diagram of an apparatus for data processing according to an embodiment of the present disclosure;

FIG. 8 is a structural schematic diagram of an apparatus for data processing according to an embodiment of the present disclosure;

FIG. 9 is a structural schematic diagram of an apparatus for data processing according to an embodiment of the present disclosure; and

FIG. 10 is a structural schematic diagram of an apparatus for data processing according to an embodiment of the present disclosure.

### DETAILED DESCRIPTION OF EMBODIMENTS

The technical solutions in the embodiments of the present application will be described clearly and completely hereinafter in conjunction with the drawings in the embodiments of the present application. Apparently, the described embodiments are only some embodiments of the present disclosure, rather than all embodiments. Based on the embodiments in the present application, all of other embodiments, made by the person skilled in the art without any creative efforts, fall in the scope of protection of the present application.

In the present application, the term “include”, “comprise” or any variant thereof is intended to encompass nonexclusive inclusion so that a process, method, article or device including a series of elements includes not only those elements but also other elements which have not been listed definitely or an element(s) inherent to the process, method, article or device. Moreover, the expression “comprising a(n)” in which an element is defined will not preclude presence of an additional identical element(s) in a process, method, article or device comprising the defined element(s) unless further defined.

A method for data processing is provided according to an embodiment of the present disclosure. Referring to FIG. 1, the method includes at least the following steps S101 to S103.

In step S101, compressed image data is received.

It is noted that, the compressed image data includes N pieces of compressed image slice data, and each piece of compressed image slice data includes invalid data and valid data.

In the process of compressing image data, an original image is divided into multiple image slices. A height and a width of each image slice may be configured freely within a certain range. Data of each image slice is valid data in the compressed image data. Preferably in the present disclosure, a horizontal width of the image slice is compressed while a vertical height of the image slice remains unchanged. It is noted that, the compression performed on the image slice is not limited to the compression of the horizontal width of the image slice in the present disclosure.

After the image slices are compressed, compression ratios of the image slices are different from each other. In order to keep the compression ratios of all the image slices consistent with each other, invalid data is added to compressed data of each image slice, to make sure that each piece of compressed image slice data meets a certain compression ratio.

In the present disclosure, optionally, zero is used as the invalid data to be added.

For better understanding the invalid data, an example is taken for further illustration in the following.

For example, the original image is divided into four identical image slices. Compression is performed on each image slice by a compression ratio of N, in which a width of each image slice becomes 1/N of an original width of the image slice, while a vertical height of each image slice keeps unchanged. To make a total data size of the four pieces of compressed image slice data (compressed data of the four image slices) equal to 1/N of that of the original image, invalid data is added at the end of each piece of compressed image slice data.

In step S102, on detecting that a preset amount of invalid data has been continuously written in the memory during the process of sequentially storing the N pieces of compressed image slice data into a memory, writing of a piece of compressed image slice data corresponding to the invalid data is stopped.

It is noted that, in the process of detecting whether the preset amount of invalid data has been written in the memory continuously, the amount of invalid data of the piece of compressed image slice data written in the memory is monitored during the process of storing the piece of compressed image slice data into the memory, and when the amount of the invalid data reaches a preset value, it is determined that an area of the piece of compressed image slice data currently being written in the memory is an invalid data area of the piece of compressed image slice data for storing invalid data, and writing of the piece of compressed image slice data corresponding to the invalid data is stopped.

The valid data in the piece of compressed image slice data is a binary data or data in other formats, thus the valid data includes zeros, but does not include multiple consecutive zeros, while the invalid data in the compressed image slice data includes a mass of consecutive zeros.

For better understanding, an example is taken for further illustration in the following.

For example, it may be determined that the valid data area of the piece of compressed image slice data is detected in a case that sixteen zeros are consecutively written. During the process of storing a piece of compressed image slice data into the memory, counting of the amount of invalid data is started when a first zero is detected. If a fifteenth zero is detected but a sixteenth digit next to the fifteenth zero is not zero, a current count is cleared. The number of zeros is counted again when a next zero is detected, and if sixteen zeros are detected consecutively, it is determined that an area of the piece of compressed image slice data currently being written into the memory is an invalid data area of the piece of compressed image slice data for storing invalid data, and the rest invalid data of the piece of compressed image slice data will not be written in the memory.

In step S103, the piece of compressed image slice data stored in the memory is read, the valid data in the piece of compressed image slice data is decoded, and an image slice corresponding to the piece of compressed image slice data is obtained.

It is noted that, during the process of reading the piece of compressed image slice data, the number of invalid data in the read piece of compressed image slice data is counted. In a case that the amount of the invalid data reaches a preset value, it is determined that an area of the piece of compressed image slice data in the memory currently being read is an invalid data area of the piece of compressed image slice data for storing invalid data, and reading of data from the memory is stopped.

For better understanding, an example is taken for further illustration in the following.

Based on the example illustrated in the above step S102, the piece of compressed image slice data stored in the memory includes the valid data and the invalid data of sixteen zeros. During the process of reading the piece of compressed image slice data in the memory, counting of the amount of the invalid data is started when a first zero is detected. If a fifteenth zero is detected but a sixteenth digit next to the fifteenth zero is not zero, a current count is cleared. The number of zeros is counted again when a next zero is detected, and if sixteen zeros are detected consecutively, it is determined that an area of the piece of compressed image slice data in the memory currently being read is an invalid data area of the piece of compressed image slice data for storing invalid data, and reading of data from the memory is stopped.

According to the method for data processing according to the present disclosure, compressed image data is received, the compressed image data includes N pieces of compressed image slice data, and each piece of compressed image slice data includes invalid data and valid data; on detecting that a preset amount of invalid data has been continuously stored in the memory during the process of sequentially storing the N pieces of compressed image slice data into a memory, writing of a piece of compressed image slice data corresponding to the invalid data into the memory is stopped; and the piece of compressed image slice data stored in the memory is read, and valid data in the piece of compressed image slice data is decoded to obtain an image slice corresponding to the piece of compressed image slice data. By the above method for data processing, the large amount of invalid data in the compressed image data is not stored in the memory, and it is not required that only after compressed image data of a frame is completed stored in the memory can the data in the memory be read and decoded. In this way, compressed image slice data in the memory can be read when compressed image slice data is being written, thereby greatly reducing capacity requirement on the memory.

Further, after the step S102 is executed, the method further includes: storing, on detecting valid data of a next piece of compressed image slice data in the compressed image data, the next piece of compressed image slice data into the memory.

It is noted that, the invalid data is added at end of the valid data. If valid data is detected, it indicates that a next piece of compressed image slice data including the detected valid data is detected. Therefore, when the valid data of the next piece of compressed image slice data in the compressed image data is detected, writing of the next piece of compressed image slice data into the memory is started, and writing of the piece of compressed image slice data into the memory is stopped when invalid data of the next piece of compressed image slice data is detected.

According to the embodiment, writing of the next piece of compressed image slice data is started on detecting the valid data of the next piece of compressed image slice data. In this way, the next piece of compressed image slice data can be written into the memory continuously after the current piece of compressed image slice data has been written, rendering data transmission continuous and thereby improving transmission efficiency.

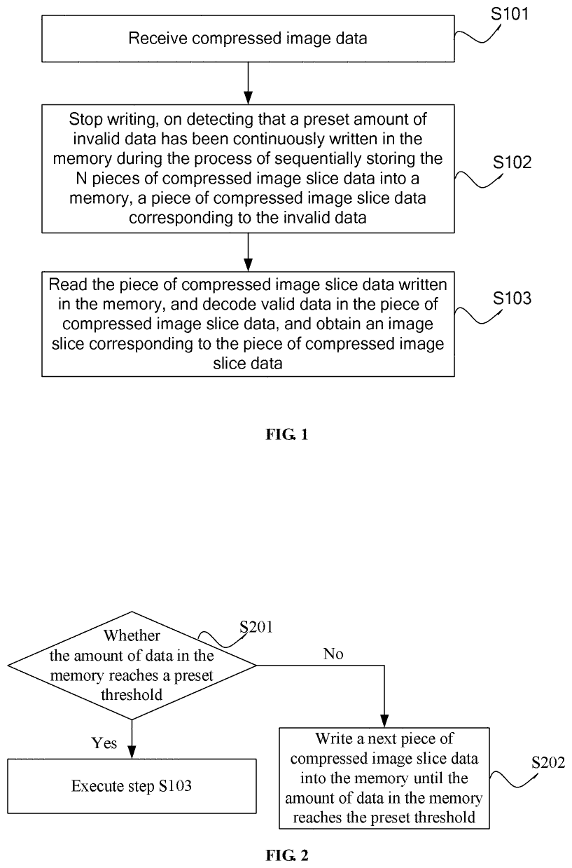

Before the step S103 is executed, as shown in FIG. 2, the method further includes the following steps S201 to S202.

In step S201, whether the amount of data in the memory reaches a preset threshold is determined. If it is determined that the amount of data in the memory reaches the preset threshold, step S103 is executed. If it is determined that the amount of data in the memory does not reach the preset threshold, step S202 is executed.

In step S202, the next piece of compressed image slice data is stored into the memory until the amount of data in the memory reaches the present threshold.

It is noted that, if the memory is large enough to store multiple pieces of compressed image slice data, the compressed image slice data stored in the memory may be read after the multiple pieces of compressed image slice data are stored in the memory.

According to the embodiment of the present application, it is determined that whether the amount of data in the memory reaches the preset threshold. If the amount of data in the memory does not reach the preset threshold, the next piece of compressed image slice data is stored into the memory, until the amount of data in the memory reaches the preset threshold. Thus capability of the memory is utilized reasonably, and resources of the memory are not wasted.

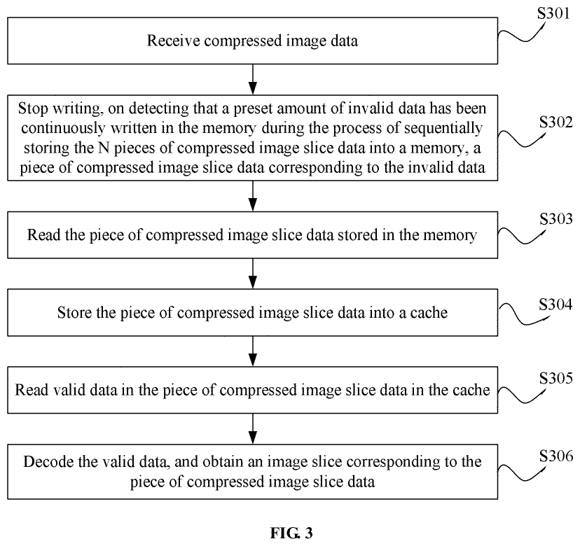

Referring to FIG. 3, a method for data processing is provided according to an embodiment of the present disclosure. The method for data processing includes the following steps S301 to S306.

In step S301, compressed image data is received.

In step S302, on detecting that a preset amount of invalid data has been continuously written in the memory during the process of sequentially storing the N pieces of compressed image slice data into a memory, writing of a piece of compressed image slice data corresponding to the invalid data is stopped.

It is noted that, the principle and detailed process of steps S301 and S302 are similar as that of steps S101 and S102 as shown in FIG. 1, and reference may be made to the above description, which is not described again herein for simplicity.

Preferably, after step S302 is executed, the method further includes: storing, on detecting valid data of a next piece of compressed image slice data in the compressed image data, the next piece of compressed image slice data into the memory.

It is noted that, the invalid data is added at end of the valid data. If valid data is detected, it indicates that a next piece of compressed image slice data including the detected valid data is detected. When the valid data of the next piece of compressed image slice data in the compressed image data is detected, writing of the next piece of compressed image slice data into the memory is started.

In step S303, the piece of compressed image slice data stored in the memory is read.

It is noted that, step S303 is executed once the piece of compressed image slice data exists in the memory, where the piece of compressed image slice data in the memory is read directly.

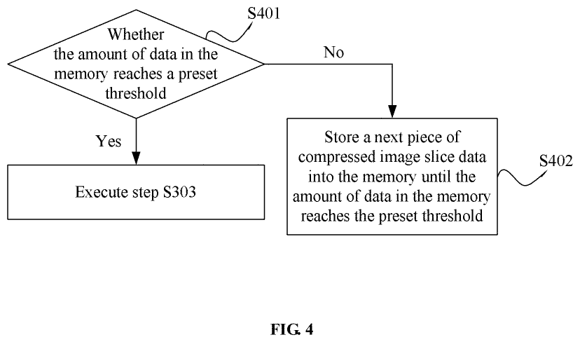

Further, before executing the step S303 of reading the piece of compressed image slice data stored in the memory, following steps S401 to S402, as shown in FIG. 4, may be executed.

In step S401, it is determined that whether the amount of data in the memory reaches a preset threshold. The step S303 is executed if it is determined that the amount of data in the memory reaches the preset threshold. Step S402 is executed if it is determined that the amount of data in the memory does not reach the preset threshold.

The amount of data refers to the amount of the stored compressed image slice data.

In step S402, a next piece of compressed image slice data is stored into the memory until the amount of data in the memory reaches the preset threshold.

It is noted that, if the memory is large enough to store multiple pieces of compressed image slice data, the compressed image slice data stored in the memory may be read after the multiple pieces of compressed image slice data are stored in the memory. In this way, capability of the memory is utilized reasonably, and the purpose of no waste of resources of the memory is better achieved.

In step S304, the piece of compressed image slice data is stored in a cache.

In step S305, the valid data in the piece of compressed image slice data stored in the cache is read.

It is noted that, the piece of compressed image slice data stored in the cache includes valid data and invalid data and the valid data is read.

In step S306, the valid data is decoded, and an image piece corresponding to the piece of compressed image slice data is obtained.

It is noted that, the step of decoding the valid data refers to decoding the valid data in the piece of compressed image slice data. After the valid data is decoded, the valid data in the piece of compressed image slice data is restored to a corresponding image slice.

Preferably, after step S306 is executed, the method further includes: deleting invalid data in the piece of compressed image slice data in the cache.

It is noted that, the piece of compressed image slice data includes valid data and invalid data. After the valid data is decoded into the image slice corresponding to the piece of compressed image slice data, the invalid data still exists in the cache. In order prevent the invalid data from occupying cache resources, the invalid data in the piece of compressed image slice data in the cache is deleted.

According to the method for data processing according to the present disclosure, compressed image data is received, the compressed image data includes N pieces of compressed image slice data, and each piece of compressed image slice data includes invalid data and valid data; on detecting that a preset amount of invalid data has been continuously stored in the memory during the process of sequentially storing the N pieces of compressed image slice data into a memory, writing of a piece of compressed image slice data corresponding to the invalid data into the memory is stopped; and the piece of compressed image slice data stored in the memory is read, and is stored in a cache, and the valid data of the piece of compressed image slice data in the cache is read and decoded to obtain an image slice corresponding to the piece of compressed image slice data. By the above method for data processing, the large amount of invalid data in the compressed image data is not stored in the memory, and it is not required that only after compressed image data of a frame is completed stored in the memory can the data in the memory be read and decoded. In this way, compressed image slice data in the memory can be read when compressed image slice data is being written, thereby greatly reducing capacity requirement on the memory.

Referring to FIG. 5, a method for data processing is provided according to an embodiment of the present disclosure. The method for data processing includes the following steps S501 to S509.

In step S501, it is determined that whether data to be transmitted is a kind of data in an image set. Step S502 is executed if the data to be transmitted is compressed image data in the image set. Step S503 is executed if the data to be transmitted is original image data in the image set.

It is noted that, the data in the image set includes compressed image data and original image data.

In step S502, the compressed image data is transmitted through a video transmission interface, where the compressed image data includes N pieces of compressed image slice data.

It is noted that, an hdmi (high definition multimedia interface) 1.4 video transmission interface is preferred in the present disclosure to transmit the compressed image data, where the video transmission interface in the present disclosure is not limited to the hdmi 1.4 video transmission interface. If the hdmi 1.4 video transmission interface is applied to transmit the compressed image data, vertical synchronous data and horizontal synchronous data matching with the compressed image data is to be configured.

In step S503, the original image data is divided into N image slices, compression is performed on each of the N image slices to obtain compressed image data, and the compressed image data obtained is transmitted through a video transmission interface.

It is noted that, the original image data may be large data. As the transmission capability of a channel is limited, it is required to divide the original image data into N pieces, that is, N image slices. Then compression is performed on the N image slices. After being compressed, the N images are packaged and transmitted through the video transmission interface.

During the process of executing step S503, the step of performing compression on each of the N image slices includes the following steps.

First, a width of each of the N image slices is compressed, to obtain compressed data of each image slice.

It is noted that, the width of the compressed data of each image slice is compressed according to a preset compression ratio. Preferably, a horizontal width of the compressed data of the image slice is compressed, where the compression is not limited to compression on the horizontal width of the compressed data of the image slice.

Second, invalid data is added at end of the compressed data of each image slice to make sure that the compressed data of each image slice meets a preset compression ratio, and compressed image data corresponding to the N image slices is obtained.

It is noted that, a transmission speed of the video transmission interface is related to the compression ratio. When a size of image data is compressed to 1/N of a size of an original image, the transmission speed of the video interface is reduced to 1/N of an original transmission speed. And a larger capability is required by the memory if the transmission speed increases. Therefore, if the capacity of the memory is constant, the compressed data of each image slice should meet the preset compression ratio, to ensure a balance between storing data in the memory and reading data from the memory.

Preferably, vertical synchronous data and horizontal synchronous data matching with the compressed data are configured.

It is noted that, if the hdmi 1.4 video interface is applied to transmit the compressed image data, vertical synchronous data and horizontal synchronous data matching with the compressed image data should be configured, to meet transmission requirements of the hdmi 1.4 video interface.

In step S504, the compressed image data transmitted through the video transmission interface is received, where the compressed image data includes N pieces of compressed image slice data and each piece of compressed image slice data includes invalid data and valid data.

In step S505, on detecting that a preset amount of invalid data has been continuously stored in the memory during the process of sequentially storing the N pieces of compressed image slice data into a memory, writing of a piece of compressed image slice data corresponding to the invalid data into the memory is stopped.

Preferably, after step S505 is executed, the method further includes: writing, on detecting valid data of a next piece of compressed image slice data in the compressed image data, the next piece of compressed image slice data into the memory.

It is noted that, the invalid data is added at end of the valid data. If valid data is detected, it indicates that a next piece of compressed image slice data including the detected valid data is detected. Therefore, when the valid data of the next piece of compressed image slice data in the compressed image data is detected, writing of the next piece of compressed image slice data into the memory is started.

In step S506, the piece of compressed image slice data stored in the memory is read.

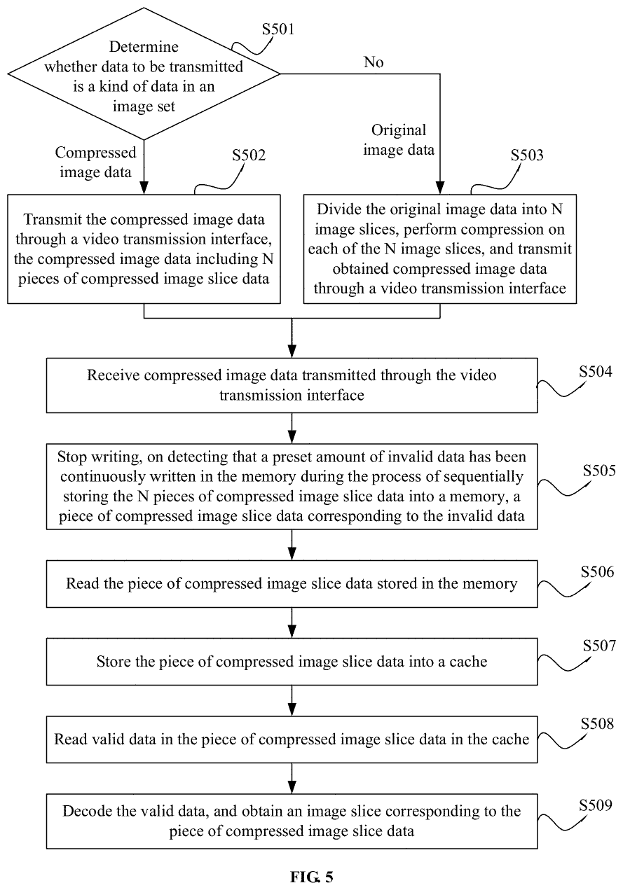

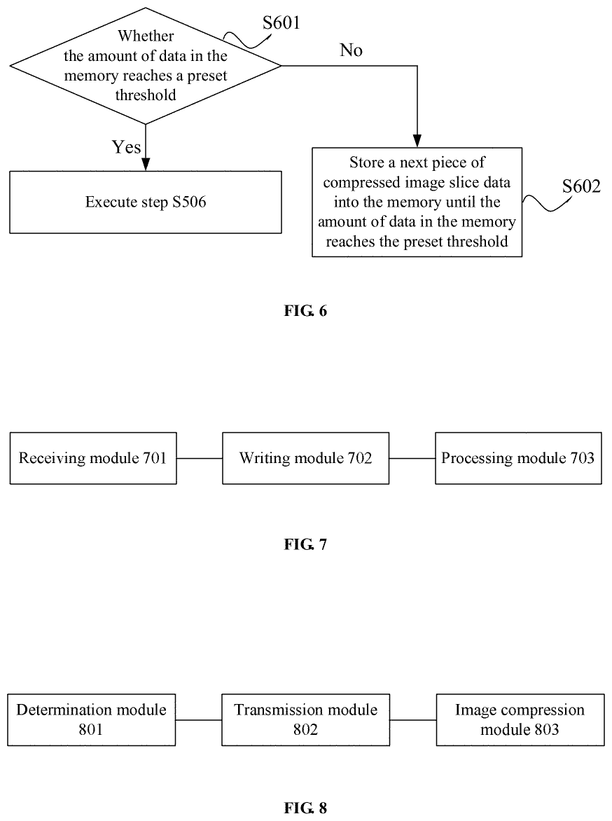

Further, before executing the step S506 of reading the piece of compressed image slice data stored in the memory, following steps S601 to S602, as shown in FIG. 6, may be executed.

In step S601, it is determined that whether the amount of data in the memory reaches a preset threshold. The step S506 is executed if it is determined that the amount of data in the memory reaches the preset threshold. Step S602 is executed if it is determined that the amount of data in the memory does not reach the preset threshold.

In step S602, a next piece of compressed image slice data is stored into the memory until the amount of data in the memory reaches the preset threshold.

It is noted that, if the memory is large enough to store multiple pieces of compressed image slice data, the compressed image slice data stored in the memory may be read after the multiple pieces of compressed image slice data are stored in the memory.

In step S507, the piece of compressed image slice data is stored in a cache.

In step S508, the valid data in the piece of compressed image slice data stored in the cache is read.

In step S509, the valid data is decoded, and an image piece corresponding to the piece of compressed image slice data is obtained.

It is noted that, the principle and detailed process of steps S504 to S509 are similar as that of steps S301 to S306 as shown in FIG. 3, and reference may be made to the above description, which is not described again herein for simplicity.

Preferably, after step S509 is executed, the method further includes: deleting invalid data in the piece of compressed image slice data in the cache.

It is noted that, the piece of compressed image slice data includes valid data and invalid data. After the valid data is decoded into the image slice corresponding to the piece of compressed image slice data, the invalid data still exists in the cache. In order prevent the invalid data from occupying cache resources, the invalid data in the piece of compressed image slice data in the cache is deleted.

According to the method for data processing provided according to the present disclosure, it is determined that whether data to be transmitted is a kind of data in an image set, where the image set includes compressed image data and original image data; if the data to be transmitted is the compressed image data in the image set, the compressed image data is transmitted through a video transmission interface, where the compressed image data includes N pieces of compressed image slice data; if the data to be transmitted is the original image data in the image set, the original image data is divided into N image slices, compression is performed on each of the N image slices to obtain compressed image data, and the compressed image data obtained is transmitted through the video transmission interface; the compressed image data transmitted through the video transmission interface is received, where the compressed image data includes N pieces of compressed image slice data, and each piece of compressed image slice data includes invalid data and valid data; on detecting that a preset amount of invalid data has been continuously stored in the memory during the process of sequentially storing the N pieces of compressed image slice data into a memory, writing of a piece of compressed image slice data corresponding to the invalid data into the memory is stopped; the piece of compressed data image slice stored in the memory is read and is stored in a cache; and the valid data of the piece of compressed image slice data in the cache is read and decoded, to obtain an image slice corresponding to the piece of compressed image slice data. By the above method for data processing, the large amount of invalid data in the compressed image data is not stored in the memory, and it is not required that only after compressed image data of a frame is completed stored in the memory can the data in the memory be read and decoded. In this way, compressed image slice data in the memory can be read when compressed image slice data is being written, thereby greatly reducing capacity requirement on the memory.

Corresponding to the method for data processing according to the embodiments of the present disclosure, an apparatus for data processing is provided according to an embodiment of the present disclosure. As shown in FIG. 7, the apparatus for data processing includes: a receiving module 701, a writing module 702 and a processing module 703,

where the receiving module 701 is configured to: receive compressed image data, where the compressed image data includes N pieces of compressed image slice data and each piece of compressed image slice data includes invalid data and valid data,

the writing module 702 is configured to: stop writing, on detecting that a preset amount of invalid data has been continuously written in a memory during the process of sequentially storing the N pieces of compressed image slice data into the memory, a piece of compressed image slice data corresponding to the invalid data, and

the processing module 703 is configured to: read the piece of compressed image slice data written in the memory, and decode valid data in the piece of compressed image slice data to obtain an image slice corresponding to the piece of compressed image slice data.

Preferably, the apparatus for data processing further includes a detection module configured to store, on detecting valid data of a next piece of compressed image slice data in the compressed image data, the next piece of compressed image slice data into the memory.

Preferably, the apparatus for data processing, as shown in FIG. 8, further includes: a determination module 801, a transmission module 802 and an image compression module 803,

where the determination module 801 is configured to: determine whether data to be transmitted is a kind of data in an image set, where the data in the image set includes compressed image data and original image data, where in a case that the data to be transmitted is the compressed image data in the image set, the transmission module is executed and in a case that the data to be transmitted is the original image data in the image set, the image compression module is executed,

the transmission module 802 is configured to: transmit the compressed image data through a video transmission interface, where the compressed image data includes N pieces of compressed image slice data, and

the image compression module 803 is configured to: divide the original image data into N image slices, compress each of the N image slices and transmit obtained compressed image data through the video transmission interface.

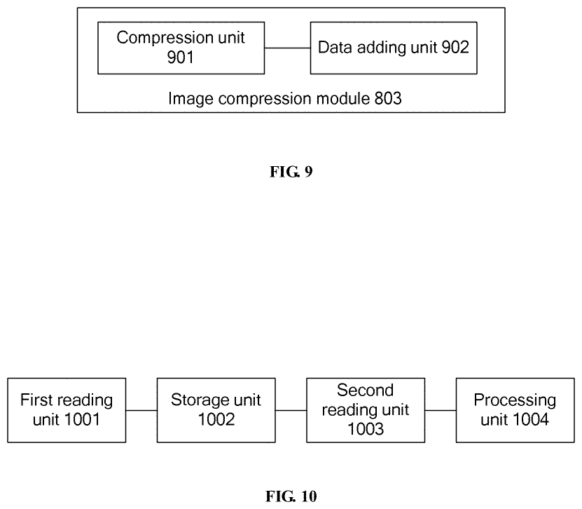

Preferably, the image compression module 803, as shown in FIG. 9, includes a compression unit 901 and a data adding unit 902,

where the compression unit 901 is configured to compress a width of each of the N image slices, to obtain compressed data of each image slice, and

the data adding unit 902 is configured to add invalid data at the end of the compressed data of each image slice to conform each image slice to a preset compression ratio, to obtain compressed image data corresponding to the N image slices.

Preferably, the apparatus for data processing further includes a threshold determination module configured to: determine whether the amount of data in the memory reaches a preset threshold; execute the processing module 703 in a case that the amount of data in the memory reaches the preset threshold; and execute the writing module 702 in a case that the amount of data in the memory does not reach the preset threshold, to write a next piece of compressed image slice data into the memory until the amount of data in the memory reaches the preset threshold.

Preferably, the processing module 703, as shown in FIG. 10, includes:

a first reading unit 1001, configured to read the piece of compressed image slice data stored in the memory;

a storage unit 1002, configured to store the piece of compressed image slice data into a cache;

a second reading unit 1003, configured to read the valid data in the piece of compressed image slice data stored in the cache; and

a processing unit 1004, configured to decode the valid data, to obtain the image slice corresponding to the piece of compressed image slice data.

Preferably, the processing module 703 further includes a deletion unit configured to delete invalid data in the piece of compressed image slice data in the cache.

In the apparatus for data processing provided according to the present disclosure, the receiving module receives compressed image data, the writing module stops writing, on detecting that a preset amount of invalid data has been continuously stored in the memory during the process of sequentially storing the N pieces of compressed image slice data into a memory, a piece of compressed image slice data corresponding to the invalid data into the memory, and the processing module reads the piece of compressed image slice data stored in the memory and obtains an image slice corresponding to the piece of compressed image slice data by decoding valid data in the piece of compressed image slice data. By the above apparatus for data processing, the large amount of invalid data in the compressed image data is not stored in the memory, and it is not required that only after compressed image data of a frame is completed stored in the memory can the data in the memory be read and decoded. In this way, compressed image slice data in the memory can be read when compressed image slice data is being written, thereby greatly reducing capacity requirement on the memory.

It is noted that the foregoing method and apparatus for data processing may be implemented by a computer device. The computer device includes a processor and a storage medium with processor executable instructions stored thereon, and the processor implements the steps of the method for data processing and the functions of various modules and units in the apparatus according to any of the proceeding embodiments by executing the instructions stored on the storage medium. The computer device may further include a memory and/or a cache as referred to in the foregoing embodiments to include the functions of the memory and/or the cache cited in these embodiments.

It is further noted the integrated unit, if implemented in the form of a software functional unit and sold or used as a standalone product, may be stored in a computer readable storage medium. Based on such understanding, the essence or the part contributing to the prior art of the technical solution of the present disclosure, or all or parts of the technical solution, may be embodied in the form of a software product. The soft product of the computer is stored in a storage medium, and includes a number of instructions which enable a computer device (which may be a personal computer, a server or a network device, etc.) to perform all or part of the steps of the methods described in various embodiments of the present disclosure. The foregoing storage medium includes: a U disk, a Read-Only Memory (ROM), a Random Access Memory (RAM), a portable hard disk, a magnetic disk, or an optical disk, and the like.

The embodiments in this specification are described in a progressive manner. For the same or similar parts between the embodiments, one may refer to the description of other embodiments. Each embodiment lays emphasis on differences from other embodiments. Since the system embodiment is similar to the method embodiment, the description for the system embodiment is relatively simple. For related parts, reference may be made to description in the method embodiment. The system embodiment described above are merely illustrative, and units described as separate components may or may not be physically separated. The components shown as units may be or not be physical units, i.e., the units may be located at the same place or may be distributed onto multiple network units. All or a part of the modules may be selected based on actual needs to realize the objective of the solutions according to the embodiments. The solutions according to the embodiments can be understood and implemented by those skilled in the art without creative work.

The person skilled in the art can further appreciate that the elements and algorithm steps of each embodiment described in conjunction with the embodiments disclosed herein can be implemented in electronic hardware, computer software or a combination of both, in order to clearly illustrate the interchangeability of the hardware and software, the composition and steps of the various examples have been generally described in terms of function in the above description. Whether these functions are performed in form of hardware or software depends on the specific application and design constraints of the technical solution. The person skilled in the art can use different methods for implementing the described functions for each particular application, such implementation shall not be considered beyond the scope of the present disclosure.

Based on the above description of the disclosed embodiments, those skilled in the art are capable of carrying out or using the present disclosure. It is obvious for those skilled in the art to make many modifications to these embodiments. The general principle defined herein may be applied to other embodiments without departing from the spirit or scope of the present disclosure. Therefore, the present invention is not limited to the embodiments illustrated herein, but shall be defined by the broadest scope consistent with the principle and novel features disclosed herein.

1. A method for data processing, comprising:
receiving compressed image data, wherein the compressed image data comprises N pieces of compressed image slice data and each piece of compressed image slice data comprises invalid data and valid data;
stopping writing, on detecting that a preset number of invalid data has been continuously in the memory during the process of sequentially storing the N pieces of compressed image slice data into a memory, a piece of compressed image slice data corresponding to the invalid data; and
reading the piece of compressed image slice data written in the memory and decoding valid data in the piece of compressed image slice data to obtain an image slice corresponding to the piece of compressed image slice data.

2. The method for data processing according to claim 1, wherein after stopping writing the piece of compressed image slice data corresponding to the invalid data, the method further comprises:
storing, on detecting valid data of a next piece of compressed image slice data in the compressed image data, the next piece of compressed image slice data into the memory.

3. The method for data processing according to claim 1, wherein before receiving the compressed image data, the method further comprises:
determining whether data to be transmitted is a kind of data in an image set, wherein the data in the image set comprises compressed image data and original image data;
transmitting, in a case that the data to be transmitted is the compressed image data in the image set, the compressed image data through a video transmission interface, wherein the compressed image data comprises N pieces of compressed image slice data; and
dividing, in a case that the data to be transmitted is the original image data in the image set, the original image data into N image slices, compressing each of the N image slices, and transmitting obtained compressed image data through the video transmission interface.

4. The method for data processing according to claim 3, wherein performing compression on the N image slices comprises:
compressing a width of each of the N image slices, to obtain compressed data of each image slice; and
adding invalid data at the end of the compressed data of each image slice to conform the compressed data of each image slice to a preset compression ratio, to obtain compressed image data corresponding to the N image slices.

5. The method for data processing according to claim 1, wherein before reading the piece of compressed image slice data written in the memory, the method further comprises:
determining whether the amount of data in the memory reaches a preset threshold; and
storing the next piece of compressed image slice data into the memory until the amount of data in the memory reaches the present threshold, in a case that it is determined that the amount of data in the memory does not reach the preset threshold.

6. The method for data processing according to claim 1, wherein reading the piece of compressed image slice data written in the memory and decoding the valid data in the piece of compressed image slice data to obtain the image slice corresponding to the piece of compressed image slice data comprise:
reading the piece of compressed image slice data stored in the memory;
storing the piece of compressed image slice data into a cache;
reading the valid data in the piece of compressed image slice data stored in the cache; and
decoding the valid data, to obtain the image slice corresponding to the piece of compressed image slice data.

7. The method for data processing according to claim 2, wherein reading the piece of compressed image slice data written in the memory and decoding the valid data in the piece of compressed image slice data to obtain the image slice corresponding to the piece of compressed image slice data comprise:
reading the piece of compressed image slice data stored in the memory;
storing the piece of compressed image slice data into a cache;
reading the valid data in the piece of compressed image slice data stored in the cache; and
decoding the valid data, to obtain the image slice corresponding to the piece of compressed image slice data.

8. The method for data processing according to claim 3, wherein reading the piece of compressed image slice data written in the memory and decoding the valid data in the piece of compressed image slice data to obtain the image slice corresponding to the piece of compressed image slice data comprise:
reading the piece of compressed image slice data stored in the memory;
storing the piece of compressed image slice data into a cache;
reading the valid data in the piece of compressed image slice data stored in the cache; and
decoding the valid data, to obtain the image slice corresponding to the piece of compressed image slice data.

9. The method for data processing according to claim 4, wherein reading the piece of compressed image slice data written in the memory and decoding the valid data in the piece of compressed image slice data to obtain the image slice corresponding to the piece of compressed image slice data comprise:
reading the piece of compressed image slice data stored in the memory;
storing the piece of compressed image slice data into a cache;
reading the valid data in the piece of compressed image slice data stored in the cache; and
decoding the valid data, to obtain the image slice corresponding to the piece of compressed image slice data.

10. The method for data processing according to claim 5, wherein reading the piece of compressed image slice data written in the memory and decoding the valid data in the piece of compressed image slice data to obtain the image slice corresponding to the piece of compressed image slice data comprise:
reading the piece of compressed image slice data stored in the memory;
storing the piece of compressed image slice data into a cache;
reading the valid data in the piece of compressed image slice data stored in the cache; and
decoding the valid data, to obtain the image slice corresponding to the piece of compressed image slice data.

11. The method for data processing according to claim 6, wherein after obtaining the image slice corresponding to the piece of compressed image slice data, the method further comprises:
deleting invalid data in the piece of compressed image slice data in the cache.

12. An apparatus for data processing, comprising:
a receiving module, configured to receive compressed image data, wherein the compressed image data comprises N pieces of compressed image slice data and each piece of compressed image slice data comprises invalid data and valid data;
a writing module, configured to stop writing, on detecting that a preset amount of invalid data has been continuously written in a memory during the process of sequentially storing the N pieces of compressed image slice data into the memory, a piece of compressed image slice data corresponding to the invalid data; and
a processing module, configured to read the piece of compressed image slice data written in the memory, and decode valid data in the piece of compressed image slice data to obtain an image slice corresponding to the piece of compressed image slice data.

13. The apparatus for data processing according to claim 12, further comprising:
a detection module, configured to store, on detecting valid data of a next piece of compressed image slice data in the compressed image data, the next piece of compressed image slice data into the memory

14. The apparatus for data processing according to claim 12, further comprising:
a determination module, configured to determine whether data to be transmitted is a kind of data in an image set, wherein the data in the image set comprises compressed image data and original image data, transmit the compressed image data through a video transmission interface in a case that the data to be transmitted is the compressed image data in the image set, wherein the compressed image data comprises N pieces of compressed image slice data; and
an image compression module, configured to divide the original image data into N image slices, compress each of the N image slices and transmit obtained compressed image data through the video transmission interface, in a case that the data to be transmitted is the original image data in the image set.

15. The apparatus for data processing according to claim 14, wherein the image compression module comprises:
a compression unit, configured to compress a width of each of the N image slices, to obtain compressed data of each image slice, and
a data adding unit, configured to add invalid data at the end of the compressed data of each image slice to conform each image slice to a preset compression ratio, to obtain compressed image data corresponding to the N image slices.

16. The apparatus for data processing according to claim 12, further comprising:
a threshold determination module, configured to determine whether the amount of data in the memory reaches a preset threshold,
wherein the writing module is configured to write a next piece of compressed image slice data into the memory until the amount of data in the memory reaches the preset threshold, in a case that the amount of data in the memory does not reach the preset threshold.

17. The apparatus for data processing according to claim 12, wherein the processing module comprises:
a first reading unit, configured to read the piece of compressed image slice data stored in the memory;
a storage unit, configured to store the piece of compressed image slice data into a cache;
a second reading unit, configured to read the valid data in the piece of compressed image slice data stored in the cache; and
a processing unit, configured to decode the valid data, to obtain the image slice corresponding to the piece of compressed image slice data.

18. The apparatus for data processing according to claim 17, further comprising:
a deletion unit, configured to delete invalid data in the piece of compressed image slice data in the cache.
